(19) United States
(12) Patent Application Publication
(10) Pub. No.: US 2009/0234661 A1
(43) Pub. Date: Sep. 17, 2009

(54) ELECTRONIC MARKET TIC FEED COMPARISON

(75) Inventor: Paul John Wanish, Concord, NC (US)

Correspondence Address: TUROCY & WATSON, LLP, 127 Public Square, 57th Floor, Key Tower, CLEVELAND, OH, 44114, US

(73) Assignee: WACHOVIA CORPORATION, Charlotte, NC (US)

(21) Appl. No.: 12/047,078

(22) Filed: Mar. 12, 2008

(51) Int. Cl. G06Q 40/00; G06F 17/14

(52) U.S. Cl. 705/1

(57) ABSTRACT

A system (and corresponding method) to identify the quality of two related market feeds, when there is no definitive sequence number or identification that would make explicit comparisons possible is provided. The innovation establishes a unique waveform representation of market tics within feeds, compares the waveforms between feeds and is able to determine which feed was received later. This information can be provided to a trader to make informed decisions or to an algorithmic trading application to ensure utilization of the most reliable data available.

### BACKGROUND

Historically, exchange of stocks and bonds, or other trading, occurs on a trading floor. Generally, with respect to the trading activities, there are ‘bids’ and ‘asks’ for financial instruments between the buyers and sellers. It is the movement of bids and/or asks that interest a trader. Accordingly, these fluctuations enable a trader to make a decision if/when to make a purchase for a particular commodity.

Trading markets are based on bringing sellers and buyers together to strike deals that benefit both. Until late in the 20^{th} century, this was done with all parties meeting face to face, for example, on the trading floor. But in the 20^{th} century, traders moved away from the actual action by using telephones to call in orders. By the end of the 20^{th} century, computers became the communication mechanism. As a result, electronic data feeds became integrated into complex business applications. As computers became part of trading activity, high availability became a requirement. This was accomplished by a market data provider sending the same data over two independent channels so as to expedite prompt deliver. Unfortunately, this resulted in duplicative data and the dilemma of determining which feed to trust as the most current. A similar condition occurred when several vendors would deliver the same data. Again, these duplicative feeds created a situation where a trader was unsure of which feed to trust as the most current and therefore, accurate.

When there is delivery duplication, there will always be the first to arrive. For trading, processing the first occurrence of data typically is a significant financial advantage as decisions can be made before others are able to take action. Similarly, knowing which data source is providing the first arrival is critical. Alternatively, confidence in the quality of the data will be lost entirely. When the expected feed fails to deliver data (while coming from other sources), it must be dropped and other data sources used. However, accurate time-based ranking is not possible using conventional techniques.

As described above, traditionally, traders were physically on the floor where the prospective buyers would literally yell out prices and, if the seller liked the price, the seller would accept some buyer's bid. Today, there has been a shift in the manner in which stocks, bonds and others futures are traded. This shift was prompted by ever-growing popularity of computers, the Internet and digital communication generally.

Today, many traders do not physically go to the commodity or trading floor but, rather, they receive electronic data feeds which represent activity from the trading floor. These electronic feeds are most often mass distributed. Unfortunately, this information is not always delivered timely for many reasons, including bandwidth, internal processing (re-marketing), etc. With regard to re-marketing, there are companies that receive feeds, aggregate feeds and re-brand or re-market the feeds to supply to traders. Today, there are hundreds of feeds—thus, it is almost impracticable to receive each feed directly from the market floor. Thus, aggregators are often employed to help manage the feeds. As can be understood, this re-marketing can create a time-lag which frequently makes the data stale or virtually useless. But knowing the staleness of the information is the crux of the problem.

Based upon data received, some of the aggregators today make assumptions to manipulate the data prior to delivering the feed. For example, if an offer is received for Stock A at $102 and a later offer is received at $104, the aggregator will most likely drop the $102 offer as it is most probable that a trader would not be interested in the $102 offer since a higher offer ($104) was subsequently received. Unfortunately, in isolation, this seems to be a prudent choice when in reality, it might not have been. One of the problems that traditional mechanisms has with this system of unilaterally making decisions based upon one amount. In many cases, the aggregator does not know the historical data to accurately determine how best to handle the situation, for example, where not all of the data is received.

In a particular example, a trader in a particular locale can be remotely monitoring a trading floor. In other words, the trader can have a direct connection to a source which conveys information (or direct feeds) from the trading floor. Additionally, the trader receive information or other feeds, for example, from an aggregator. Oftentimes, information is duplicative and the trader is faced with a dilemma as to which source to trust as the most current or accurate. This dilemma or issue arises when there are two feeds of the same market data which arrive at different times. Unfortunately, sometimes the differences in the feeds are so subtle that even the most market savvy analyst cannot discern the differences between the feeds.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises a system (and corresponding methodology) that employs comparison technologies to establish a time-based rank of financial market electronic data feeds. Essentially, the innovation can identify, distinguish and rank duplicative data feeds related to stocks, bonds and other commodities. These actions can occur in real-time or near real-time so as to effectively enable a trader to make informed decisions based upon accurate and timely data. It will be understood that financial trading is a time-sensitive transaction, therefore, it is critical to employ the most recent and accurate data when making transaction decisions. The innovation is able to identify (and rank) this data in situations where duplicative feeds are received.

Essentially, in a situation where multiple data feeds are received from a trading floor which include duplicative data, the subject innovation is capable of determining the laggard of multiple data feeds. It will be appreciated that identification of the laggard is useful as it can be determined that this information is virtually stale in view of more recent market data. Additionally, the innovation can also determine the extent of the lag, for example, the difference in time between the feeds. This information is helpful in making trading decisions—for example, if the lag is less than ½ of a second, it can most often be decided that either feed is accurate enough to employ in trading decisions. However, if the lag is 2 or 3 seconds, it is likely that a bid will be outbid by someone else, for example, someone using a more current feed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example system that facilitates market tic feed comparison in accordance with an aspect of the innovation.

FIG. 2 illustrates an example flow chart of procedures that facilitate comparing market tic feeds in accordance with an aspect of the innovation.

FIG. 3 illustrates an example block diagram of a market tic comparison system that employs an intake component and rank determination component in accordance with aspects of the innovation.

FIG. 4 illustrates a block diagram of an example intake component in accordance with an aspect of the innovation.

FIG. 5 illustrates a block diagram of an example block diagram of a rank determination component in accordance with an aspect of the innovation.

FIG. 6 illustrates an example graphical representation of data related to 30 year U.S. Treasury notes in accordance with an aspect of the innovation. Note the separate data feeds are represented information arrival values at specific times, by “diamonds” and “squares”.

FIG. 7 illustrates an example shape of the polynomials which represents a series of points from FIG. 6.

FIG. 8 illustrates values of the polynomial coefficients of the trend “diamond” over time in accordance with an aspect of the innovation.

FIG. 9 illustrates values of the polynomial coefficients of the trend “square” over time in accordance with an aspect of the innovation.

FIG. 10 illustrates an example synthetic “diamond” history of points in accordance with an aspect of the innovation.

FIG. 11 illustrates an example synthetic “square: history of points in accordance with an aspect of the innovation.

FIG. 12 illustrates a block diagram of a computer operable to execute the disclosed architecture.

FIG. 13 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

This innovation provides mechanisms to identify the quality of two related market feeds, when there is no definitive sequence number or identification that would make explicit comparisons possible. As described above, as many traders receive multiple feeds from multiple sources, oftentimes information is repetitive. As a result, it is not possible to know which feed is the most accurate (e.g., most current) by searching for similar values in both feeds. The innovation described and claimed herein distinguishes feeds such that a trader (or other decision-maker) can make informed decisions based upon the most accurate data available via an electronic feed.

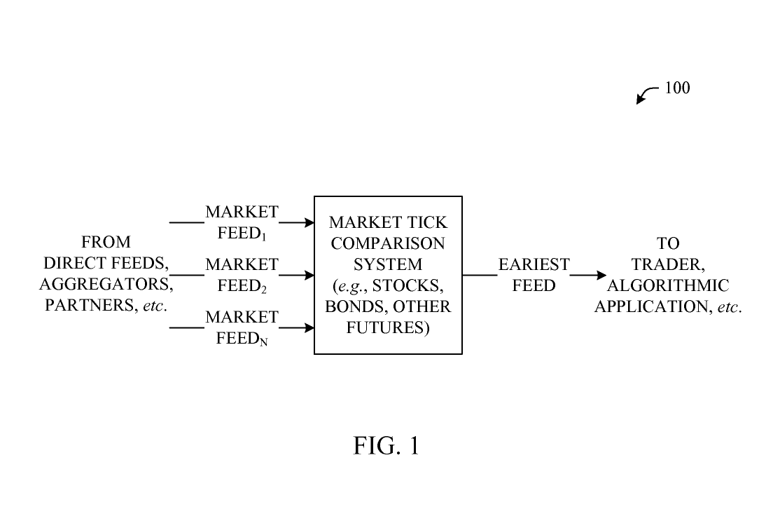

Referring initially to the drawings, FIG. 1 illustrates a system 100 that facilitates market tic feed comparison in accordance with an aspect of the innovation. Essentially, the system 100 is capable of receiving a number of market feeds related to time-sensitive trading floor transactions. As illustrated, the system 100 can receive 1 to N electronic feeds, where N is an integer.

In operation, feeds related to stocks, bonds, other futures or commodities can be received. These feeds can be received from most any source including, but not limited to, partners that provide direct feeds, aggregators, etc. As described above, oftentimes feeds received from multiple sources are duplicative, although the timing is different. It will be understood and appreciated that traders operate upon a very strict and time-sensitive schedule—thus, it is most often critical to employ the most current information available both from an accuracy and efficiency perspective. The innovation provides mechanisms by which multiple feeds can be mathematically compared in order to establish the most current (and therefore accurate) feed from a trading floor.

Once the most recent (or earliest) feed is established, a trader can employ this information to make informed trading decisions. Additionally, algorithmic trading applications can employ this information to automatically establish (or infer) transactions on behalf of a trader, for example, based upon pre-defined logic. While many of the examples described herein compare only two market feeds, it is to be understood that these examples are provided to add perspective to the innovation and are not intended to limit the innovation in any way. Rather, it is to be appreciated that the features, functions and benefits of the innovation can be employed in connection with most any number of market feeds without departing from the spirit and/or scope of the innovation. These alternative aspects are to be included within the scope of this specification and claims appended hereto.

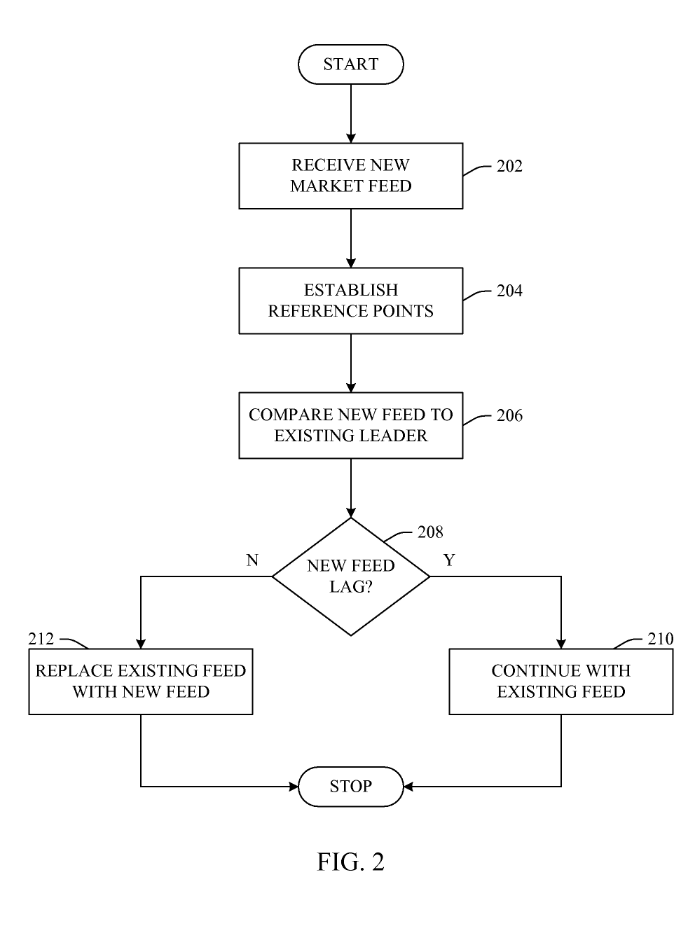

FIG. 2 illustrates a methodology of comparing market tic feeds in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202, a market tic feed is received, for example, via a direct feed or an aggregator. While the example illustrated in FIG. 2 contemplates a single feed, it is to be understood that the methodology is recursive in that it can be repeated for most any number of feeds. Essentially, a determination that a feed is lagging is indicative that the feed currently being utilized must be the most current. This analysis will be better understood upon a review of the figures that follow.

At 204, reference points can be established. Fast Fourier Transform (FFT) waveforms can be established which relate to points (or tics) within the feed. (Definition: Fast Fourier Transform (FFT) is an efficient computer algorithm designed to calculate the frequency components of sounds and other signals). The waveforms can be compared to waveforms of the existing current feed. Here, it will be understood that if a determination is made that the feed lags the existing leader then, the existing current leader must still be the most accurate feed.

At 208, the determination is made to establish if the new feed lags the existing current feed. If a determination is made that the new feed lags, at 210, the existing feed continues to be considered the most current. However, if the new feed does not lag the existing feed at 208, at 212, the existing current feed is replaced with the new feed. Thus, the new feed now becomes the existing leader. This existing leader will be employed in subsequent comparisons until a more current feed is determined. As will be understood, the innovation analyzes later feeds to establish if the existing leader is still to be considered the leader or most current feed.

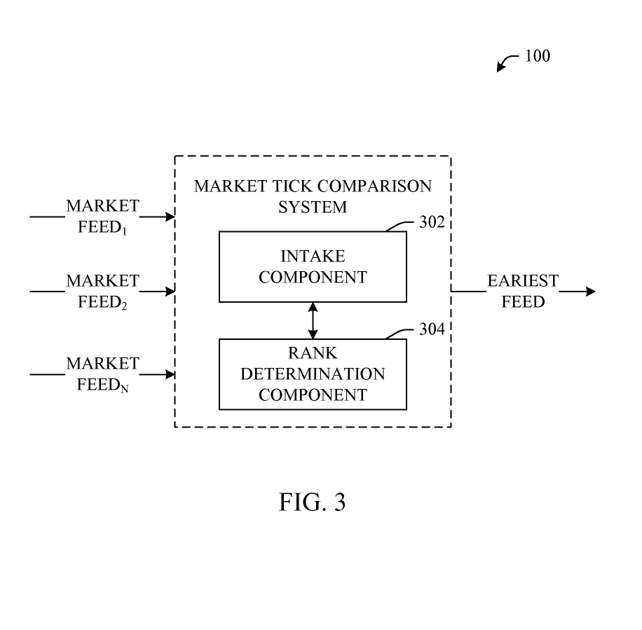

Referring now to FIG. 3, a block diagram of an example market tic comparison system 100 in accordance with an aspect of the innovation is shown. Generally, system 100 can include an intake component 302 and a rank determination component 304. Together these sub-components 302, 304 establish determination of the earliest (or most current) feed from a number of electronic market feeds.

The intake component 302 can establish reference points using mathematical algorithms. Essentially, each point (or tic) within a feed can be represented in a unique graphical form. As described supra, these representations can be employed to establish if a feed lags another feed. In other words, a more current feed is determined by the fact that another feed lags the current feed. It will be understood that if all feeds lag a particular feed, that particular feed must be determined to be the most current—this is a key premise of the innovation.

The rank determination component 304 can be employed to affect the comparison thereby establishing the most current feed. Once the most current feed is established, the rank determination component 304 can be used to validate that the most current feed remains the most current by establishing that the other feeds lag this subject feed. In doing so, the rank determination component 304 is employed to compare the FFTs of each of the tic within the feeds to establish the appropriate order of feeds from the trading floor.

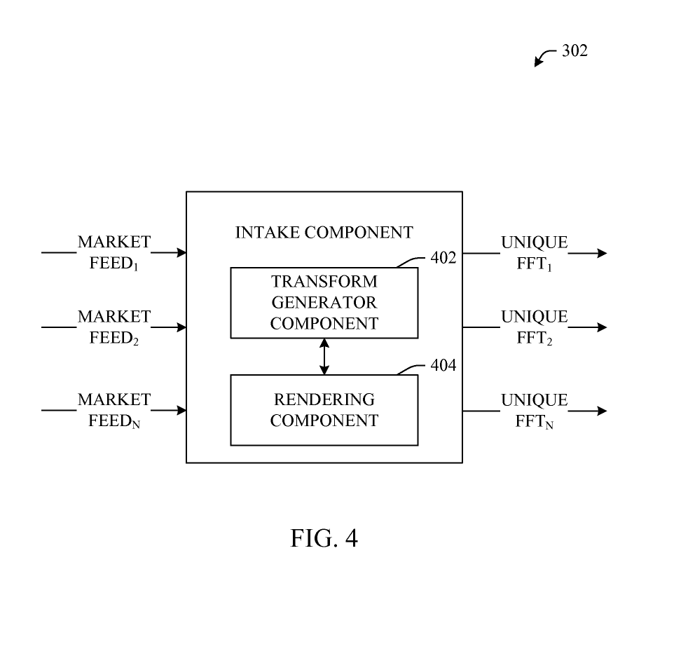

Turning now to FIG. 4, a block diagram of an example intake component 302 in accordance with an aspect of the innovation is shown. Generally, the intake component 302 can include a transform generator component 402 and a rendering component 404 which together facilitate establishing a unique transform of market tics in received feeds and provide the transform information for analysis respectively. As described above, the transforms (e.g., FFT) can be employed to provide a unique mapping of market tics to enable discovery of duplicative information.

As described supra, the subject innovation is capable of determining the laggard of multiple data feeds from a trading floor. It will be appreciated that identification of the laggard is useful as it can be determined that this information is virtually stale in view of more recent market data. The innovation can also determine the extent of the lag. For example, if the lag is less than ½ of a second, it can most often be decided that either feed is accurate enough for a trader's reliance. However, if the lag even as little as 2 or 3 seconds, it is likely that a bid will be outbid by someone else, for example, someone using a more current feed. For at least this reason, a lag of only a couple of seconds can render the data virtually useless.

A trader's response to a trading floor transaction is best if based upon information that is current, for example, a feed that is received first. As well, the more current data actually enables the trader to more effectively and efficiently trade. Therefore, in today's world of data feeds, it is advantageous to determine which feed is the earliest (and therefore, the most accurate)—the innovation described and claimed herein enables this determination.

In accordance with aspects of this specification, one assumption made is that if nothing is happening in the market, data will not be received. A corollary is that all data received has some kind of movement in it, e.g., moving up, moving down. It is also known that the movement took place at a particular time event. Therefore, all of the information received from a trading floor is based upon two fundamental premises, all trades are governed by a change in price or fee (e.g., up or down), and those events occur over time not particularly in a predicable manner. The innovation employs logic (e.g., algorithmic mechanisms) based upon these two factors or variables, and subsequently draws correlations to the relationship.

In aspects, the innovation considers the price of a stock, trade, commodity, etc. and the time the price was observed to create a formula that represents trades over time. Essentially, the transform generator component 402 employs a formula to establish a unique representation (e.g., waveform) of the market tics. In one example, an FFT is employed to establish this unique representation.

For perspective, this formula employed and described herein is analogous to an FFT which is used in circuit theory as a representation of many sample points of a signal. Essentially, the innovation employs an analogous technology to when market data is received. Thus, the transform generator component 402 establishes a unique waveform that represents past market tics. It is to be appreciated that, establishment of a unique waveform is possible as the tics are constantly cycling, each having a unique point on the generated artificial or synthetic curve.

Essentially, from two market feeds, the transform generator component 402 can generate FFT's on all of the points. The innovation need not analyze the curve per se but, at each tic, the innovation evaluates each tic's representation based upon the formula (e.g., FFT). Here, as each point's formula of history is tracked, the historical representations of each point can be compared. It is to be understood that the comparison is not as a particular market tic but rather, as a representation of a curve form. In accordance with the innovation, the rendering component 404 can establish this representation. In other words, in the example, each point now does not merely represent a price but, rather, a curve form.

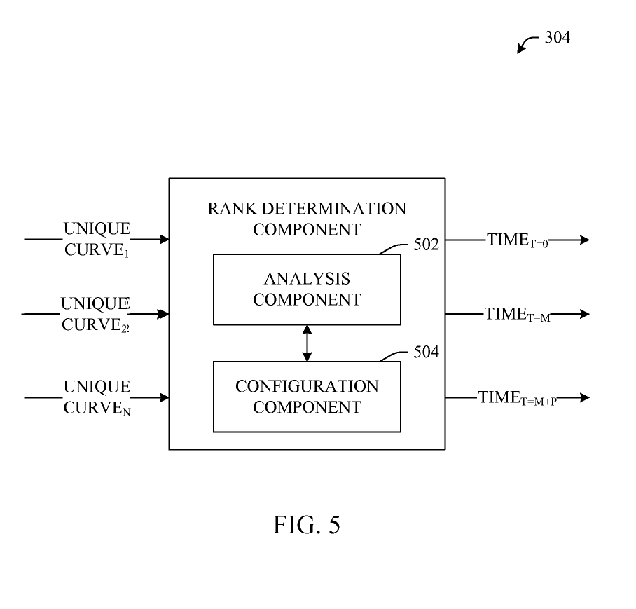

FIG. 5 illustrates an example rank determination component 304 that enables establishment of the most current feed from a number of feeds. Generally, the rank determination component 304 can include an analysis component 502 and a configuration component 504. Essentially, these sub-components (502, 504) enable analysis of the unique waveforms as well as ordering (or ranking) of the feeds based upon time.

Returning to the aforementioned example, because the waveform representation is established for each tic, the analysis component 502 can readily compare two market feeds and look back in time for points that have the same curve fit. Therefore, by comparing the waveforms, it is possible to find a similar point from another feed. It will be understood that if price were the only indicator used, when looking for a shift in time between two feeds, the price will most likely show up all of the time. In other words, as price fluctuates (e.g., $101 to $102 to $100 to $102 to $101), false matches will be indicated as it is not possible to merely determine timing and context based upon the value. However, in accordance with the innovation, if each $101 in the example above was represented by a curve or waveform that indicated prior prices, it will be possible to match a prior $101 with a current feed. Therefore, timing of the feed can be easily and accurately established.

Effectively, the innovation enables a trader to consider two (or more) feeds, and by looking of an alternate feed, the trader can accurately match up a prior tic that is the same as a feed at issue. It is to be understood that a ‘prior tic’ refers to a an earlier arrival of the same tic event (e.g., from a disparate source). As described above, this is possible as each point will not only have a unique value but, also a unique curve associated therewith. Upon comparing the feeds, the curves can be compared which can provide confidence that the tics are the same—here, a trader can act accordingly by considering the feed or otherwise ignoring it as stale. In summary, the innovation considers a market tic along with its unique curve (e.g., history) to find a match and to accurately determine the most current feed.

By establishing this comparison, the innovation is able to identify the feed that arrives at a later time. As well, it is possible to determine how much later the feed is received. One value of this information is that, when using algorithmic-trading, it is possible, in a real-time (or near real-time) manner to determine which data source is the best to base pricing and transaction decisions upon.

In other words, the innovation enables a trader to forego older feeds to enhance efficiency and effectiveness of trading. Thus, the latency of the network and processing between vendors (e.g., aggregators) can be identified and therefore, traders can act upon accurate time-sensitive data rather than data that potentially can be out-of-date, for example, where an offer may no longer available.

The innovation enables two (or more) feeds to be instrumented to be able to determine a later feed from a variety of feeds. This information can be relied upon by a trader with a level of confidence that the earlier feed is used in trading transactions. In addition to timing analysis, the innovation can also be used to establish the quality of the data delivery between vendors.

It is to be appreciated that a ‘direct feed’ is not always the fastest. Rather, other factors such as internal procedures, routing equipment, bandwidth, server capabilities, among others contribute to the latency or lack of latency of a feed. Accordingly, it will be appreciated that the subject innovation can be extremely useful in determining accuracy of data feeds regardless of the source.

Another value of the innovation is the ability to detect latency as it occurs, e.g., at peak as well as quiet market conditions. This is possible due to the sensitivity of the logic employed. This sensitivity would be difficult, if not impossible, to be replicated by human visual analysis. One key point of value of the innovation is the ability to rank the same data coming from multiple sources. Essentially, the innovation ranks which feed has been received later, and by process of elimination, determines which feed is the most current (e.g., most accurate).

In operation, as market tics are received, the feed's reference points are generated which indicate, artificially, what would have been the last two or three tics. This information is saved. Every time a tic comes in, it can be determined whether it is leading or lagging the other applications. For example, on three feeds, with regard to every tic, the prior reference points are generated. Thereafter, a comparison can be accomplished to determine which feed is lagging and if so, by how much. It will be appreciated that if a previously lagging feed, is no longer behind, the good (current) feed must no longer be the good feed. Basically, the later feeds are analyzed to determine if a new ‘good’ feed has become available based upon the timing of the feeds. In other words, the innovation employs the laggards to establish the earliest feed.

As described above, the innovation defines techniques that can provide differentiation between electronic market feeds in real-time (or near real-time) processing, when there is limited amount of information in the transmission. The following example is provided to add perspective to the innovation and is not intended to limit the scope of the innovation in any manner. Accordingly, it will be appreciated that countless examples exist which are to be included within the scope of this disclosure and claims appended hereto.

A specific example of this is the U.S. Treasury and Agency Debt trading that occurs through the TradeWeb™ consortium. In this case, the transmitted data contains a bid price for a specific instrument, for example, a 30 year note. This data feed can come directly from the consortium, or as part of other data feeds, such as from Reuters™. Complicating the process of identifying which feed is providing the first data, there are very small changes in the price at most times, as small 0.01% value and often changing in cyclic manners. Since each tic is hardly recognizable as it relates to other tics, other approaches must be employed. This innovation applies several mathematical techniques to enhance recognition.

First, it is assumed that all market feeds will capture and forward market data as soon as possible. Because of this, in general, the time spacing between all points over any feed will be consistent, even if delayed. Second, it is assumed most market tics will be propagated (some may be merged through conflation). Finally, the price, when transformed into modulo 10, is identical between the sources. Using these assumptions, the tic, along with the prior tics, is converted into a polynomial formula, for example by the intake component 302 of FIG. 3 supra. This process abstracts some of the time shifting data between the two market feeds. Then, to simplify future checks, several time values are evaluated according to this polynomial “best fit” for the history of this tic.

By applying an FFT to derive the polynomial coefficients, the single tic point, is abstracted into a curve, which provides much more uniqueness in matching. To keep from evaluating the equation each time, several time points can be chosen to simulate a form. In an example, when three points are chosen, such as at time equal zero, minus one and minus five seconds, a triangle is formed. This triangle can then be compared against the other market feed(s) for a matching shape (instead of point).

As described above, one skilled in the art will recognize the long standing problem of receiving market tics and deciding which is the most appropriate to believe, for example, determining the most accurate. Visually watching two tic feeds has frequently enabled traders to spot consistent and drastic shifts between two sources, but has not provided the technology to automate, nor the ability to identify problems with data feeds in a very quiet market. This innovation applies algorithmic methods to significantly improve the ability to quantify the time difference between two market data sources.

As described above, conventionally, traders that use computers to watch market activities and take actions on trades have to visually watch the value of tics for instruments, and then make a business decision, regardless of a high degree of confidence in the integrity and accuracy of the data. When it became possible for traders to watch multiple sources of data, the traders became exposed to two sets of data representing the same events. Inevitably, with high market activity, traders were sometimes able to visually observe that one data feed was leading the other source. This was then raised as an issue, and remedies were sought.

Unfortunately, when there was very little market activity, the human eye was unable to see the subtle time shifts in the data. Further, if and/or when the delay was observed, it was only roughly quantified. As described herein, the innovation employs algorithmic techniques to mathematically distinguish and rank electronic feed data.

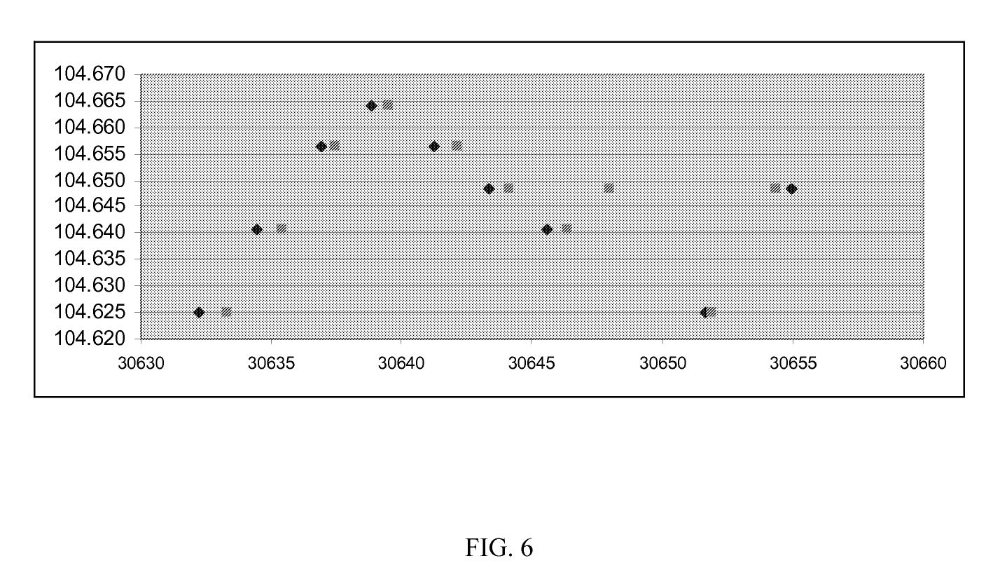

Continuing with the aforementioned example, FIG. 6 illustrates the data related to 30 year U.S. Treasury notes arriving over a 25 second period. In this chart, data coming from one provider is represented in diamonds, which the information from the other data provider is shown in squares. It is apparent from the data that the diamonds are routinely delayed in delivery. It is also apparent that not all points are delivered with the same time distribution. The following table illustrates the exact data shown in FIG. 6.

| Time (since | | |
|---|---|---|
| midnight) | Provider 1 | Provider 2 |
| 30632.203 | 104.625 | |
| 30633.296 | | 104.625 |
| 30634.468 | 104.641 | |
| 30635.390 | | 104.641 |
| 30636.921 | 104.656 | |
| 30637.437 | | 104.656 |
| 30638.859 | 104.664 | |
| 30639.515 | | 104.664 |
| 30641.234 | 104.656 | |
| 30642.150 | | 104.656 |
| 30643.375 | 104.648 | |
| 30644.150 | | 104.648 |
| 30645.578 | 104.641 | |
| 30646.375 | | 104.641 |
| 30647.984 | | 104.648 |
| 30651.671 | 104.625 | |
| 30651.875 | | 104.625 |
| 30654.328 | | 104.648 |
| 30654.930 | 104.648 | |

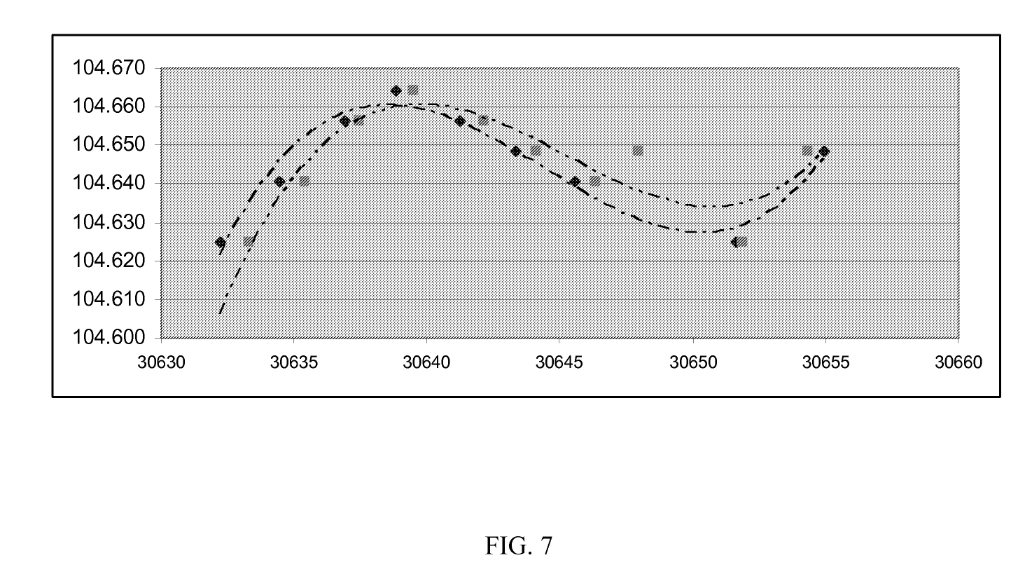

The first step of the innovation is to establish a polynomial equation that would represent a series of points. FIG. 7 illustrates the shape of the polynomial for both curves for these points. By taking a fixed amount of points, a similar curve can be established for both data providers. On each arriving market tic, the last five tics are used to calculate the coefficients of the third order polynomial. While the last five tics are used in this example, it is to be understood that more (or less) tics can be used to achieve (or effect) a desired precision. Further, although a third order polynomial is used above, this too can be changed to achieve (or effect) a desired precision. These alternative aspects are to be included within the scope of this disclosure and claims appended hereto.

As described in greater detail above, the innovation is a change in tracking from analysis of a single tic of data, to the efficient handling of tics to determine which data feed is falling behind (or delivering unreliable data). Accordingly, the prior market tics can be aggregated with the latest tic, to form an abstract representation of history. As will be understood, the history is quite different for each market tic, and therefore it is possible to reliably compare two (or more) sources for similarity (or dissimilarity). Further, if some market tics are merged, because they are either superseded or conflated into a single tic, the history of the price is not dramatically affected and continues track.

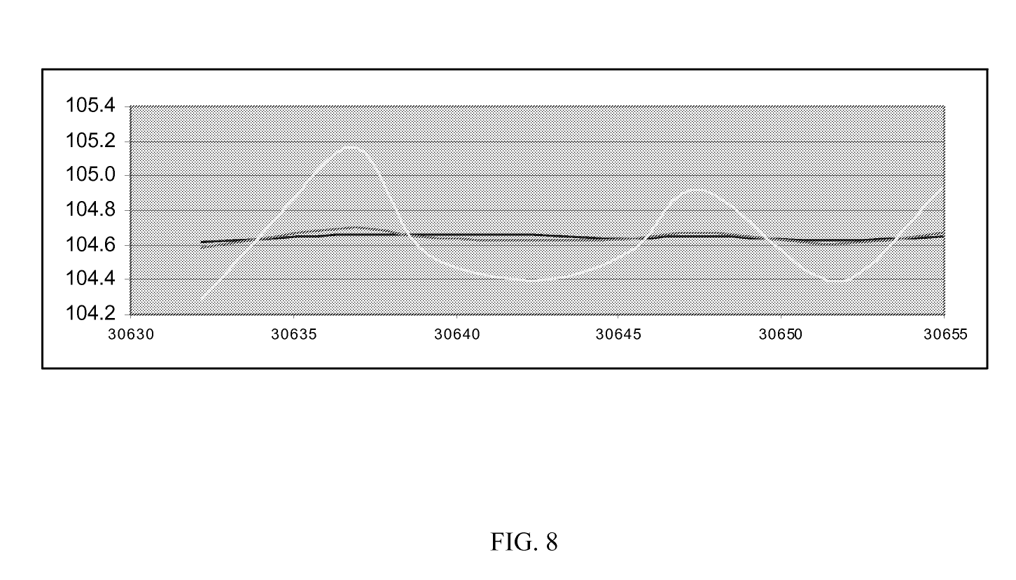

The aggregation of points can be expressed in a best fit polynomial formula. This type of representation is sometimes called a ‘trend line,’ but in this case, a unique trend line is created for each point. FIG. 8 shows both trend lines for a series of tics, coming from two sources. The lag of one feed can be clearly seen, but, it will be understood that the quantification and algorithmic process is difficult.

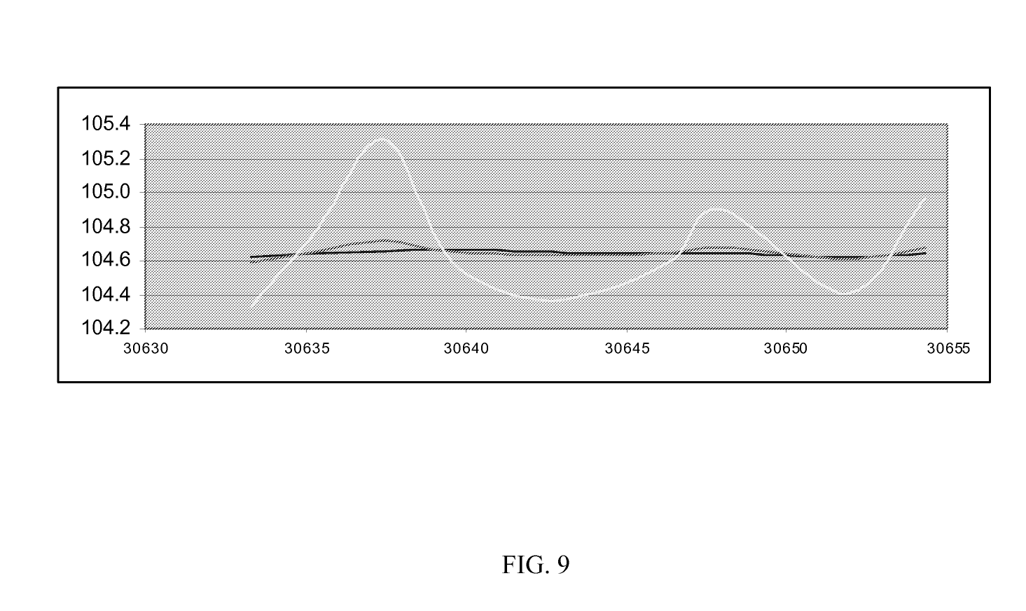

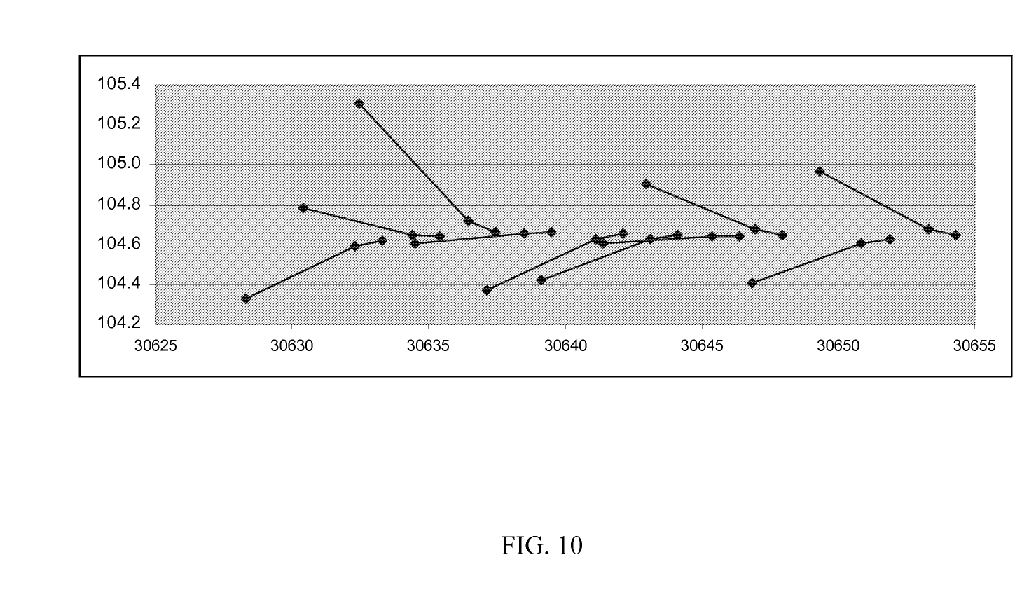

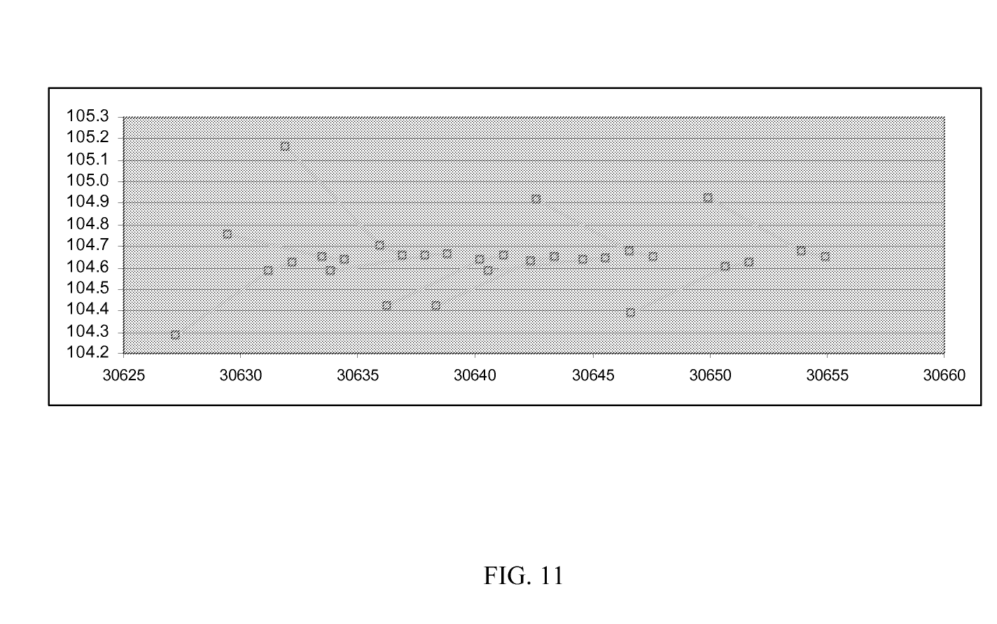

FIGS. 8 and 9 show the values of the polynomial coefficients of the expression for the point over time from both data sources. It would be possible to compare the factorials between the polynomials, but even that is difficult to do algorithmically. The second component of this innovation is to apply the polynomial to generate a set of synthetic history for each point. If both data sources are making “best efforts” to deliver data, the synthetic history would appear the same. FIGS. 10 and 11 illustrate the synthetic history points from two feeds. By iterating through these historical points, it is possible to reliably match the data coming from two sources. In accordance with the innovation, normalization of the price and time to base time values is effected. This normalization is employed to create the polynomial coefficients. Further, in aspects, the data sources must have commonality between them. Better results will be achieved when matching the time difference when comparing similar instruments. Therefore, the system works better when different instruments are separated into separate comparisons, however, this is not a requirement of the system.

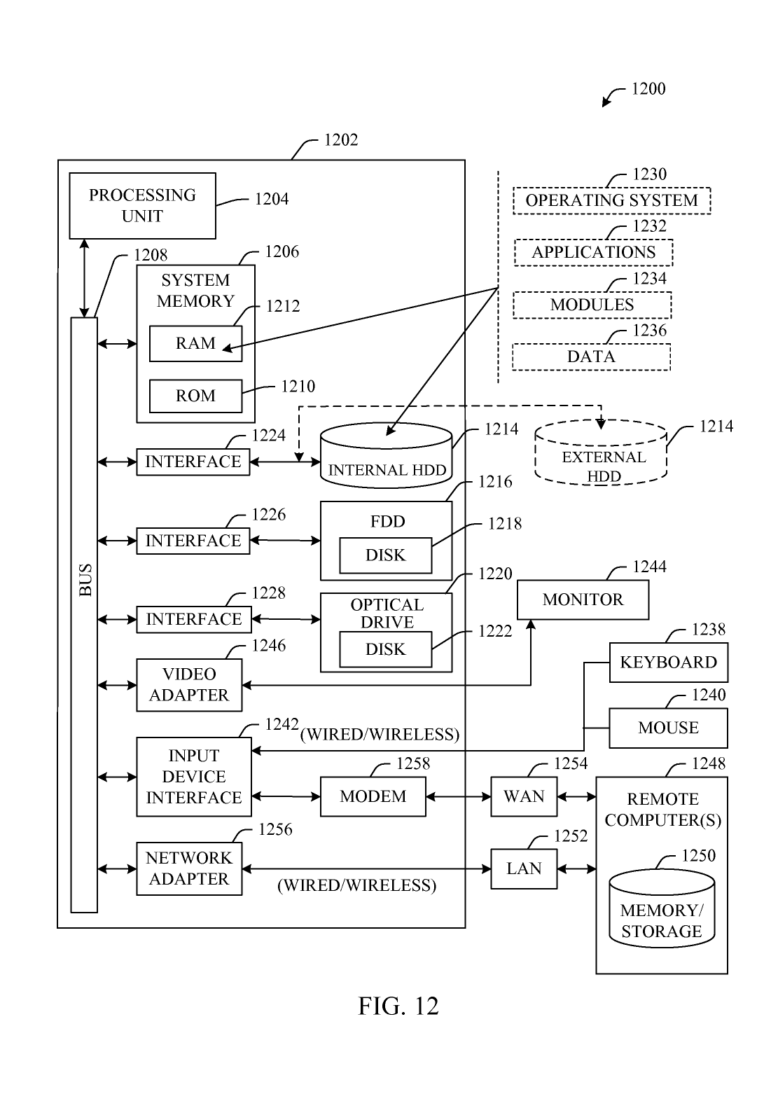

Referring now to FIG. 12, there is illustrated a block diagram of a computer operable to execute the disclosed architecture. In order to provide additional context for various aspects of the subject innovation, FIG. 12 and the following discussion are intended to provide a brief, general description of a suitable computing environment 1200 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the exemplary environment 1200 for implementing various aspects of the innovation includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the innovation can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

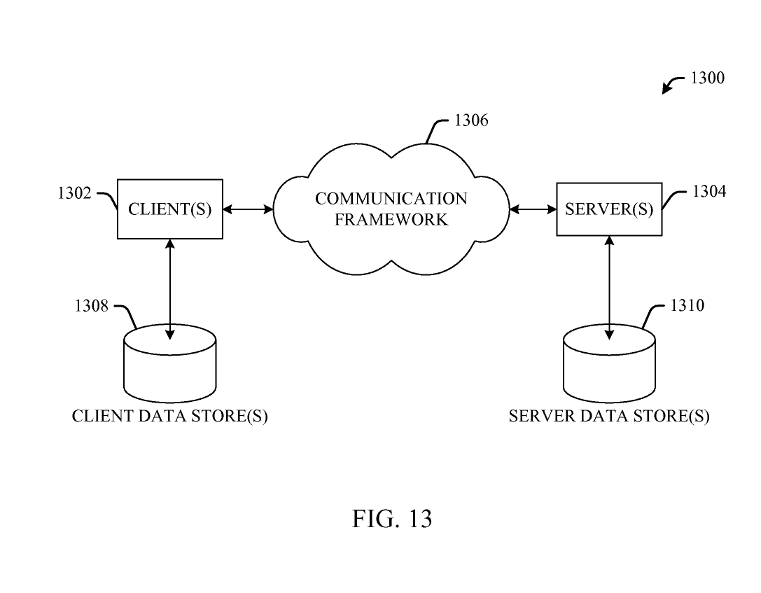

Referring now to FIG. 13, there is illustrated a schematic block diagram of an exemplary computing environment 1300 in accordance with the subject innovation. The system 1300 includes one or more client(s) 1302. The client(s) 1302 can be hardware and/or software (e.g., threads, processes, computing devices). The client(s) 1302 can house cookie(s) and/or associated contextual information by employing the innovation, for example.

The system 1300 also includes one or more server(s) 1304. The server(s) 1304 can also be hardware and/or software (e.g., threads, processes, computing devices). The servers 1304 can house threads to perform transformations by employing the innovation, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates electronic feed comparison related to a financial market, comprising:
an intake component that receives a plurality of market feeds from a source; and
a rank determination component that employs logic to establish a laggard from a subset of the plurality of market feeds.

2. The system of claim 1, wherein the rank determination component establishes the laggard in real-time.

3. The system of claim 1, wherein the source is one of a partner that provides a direct feed from a trading floor or an aggregator the re-markets feeds related to the financial market.

4. The system of claim 1, further comprising:
a transform generator component that establishes a mathematical transform of points within each feed of the subset of the plurality of market feeds; and
a rendering component that establishes a waveform associated with each of the mathematical transforms, wherein the rank determination component employs each of the waveforms to establish the laggard.

5. The system of claim 1, the transform is a Fast Fourier Transform (FFT).

6. The system of claim 5, further comprising:
an analysis component that evaluates each of the waveforms to establish the laggard; and
a configuration component that ranks the laggard amongst the subset of the plurality of market feeds.

7. A computer-implemented method of comparing financial market feeds, comprising:
receiving two of market feeds from disparate sources;
establishing a plurality of reference points based upon tics within each market feed;
generating an FFT for each tic in each of the two market feeds; and
identifying a laggard from the two market feeds, wherein the laggard identifies an earlier feed.

8. The computer-implemented method of claim 7, wherein the act of identifying the laggard includes comparing a waveform that represents tics based upon each of the two market feeds.

9. The computer-implemented method of claim 7, wherein the disparate sources are a direct feed and a re-market feed.

10. The computer-implemented method of claim 7, wherein the disparate sources are two direct feeds.

11. The computer-implemented method of claim 7, wherein the disparate sources are two re-market feeds.

12. The computer-implemented method of claim 7, further comprising establishing waveforms that represent the tics in each of the market feeds, wherein the act of identifying the laggard mathematically compares the waveforms.

13. The computer-implemented method of claim 7, further comprising determining a time delta of the laggard as a function of the earlier feed.

14. The computer-implemented method of claim 7, wherein the act of identifying the laggard occurs in real-time.

15. A computer-executable system of comparing electronic market feeds in a trading environment, comprising:
means for receiving at least two electronic market feeds from disparate sources;
means for establishing a trend line that represents each of the electronic market feeds; and
means for comparing the trend line of each of the electronic market feeds.

16. The computer-executable system of claim 15, further comprising means for determining a laggard from the at least two electronic market feeds.

17. The computer-executable system of claim 15, further comprising means for mathematically comparing the trend line of each of the electronic market feeds.

18. The computer-executable system of claim 15, further comprising means for establishing an FFT of each tic within each of the at least two market feeds, wherein the FFT is employed to establish a unique waveform associated with each of the at least two market feeds.

19. The computer-executable system of claim 15, wherein the means for establishing the trend line employs establishment of synthetic reference points associated with a tic of each of the two electronic market feeds.

20. The computer-executable system of claim 15, wherein each of the disparate sources is at least one of a direct feed or an aggregated feed.
